(19) United States
(12) Patent Application Publication
(10) Pub. No.: US 2002/0016929 A1
(43) Pub. Date: Feb. 7, 2002

(54) Computer readable recording medium with data management program recorded therein and data management system

(76) Inventors: Shuji Harashima, Fuchu-shi (JP); Chieko Kobayashi, Kawasaki-shi (JP); Asahiko Yamada, Tokorozawa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/905,864

(22) Filed: Jul. 17, 2001

(30) Foreign Application Priority Data
Jul. 17, 2000 (JP) 2000-216276

(51) Int. Cl. G06F 12/14

(52) U.S. Cl. 713/201; 707/9

(57) ABSTRACT

An access control function is provided for permitting an access only to data concerning a designated user when an access to data stored for a plurality of users occurs. Furthermore, an executing function is provided of designating the user having performed an operation with respect to the access control function, and using the access control function to access the data concerning the stored user, when an access to the stored data concerning the user is necessary in a processing based on the operation of the user.

### CROSS-REFERENCE TO RELATED APPLICATIONS

This application is based upon and claims the benefit of priority from the prior Japanese Patent Application No. 2000-216276, filed Jul. 17, 2000, the entire contents of which are incorporated herein by reference.

### BACKGROUND OF THE INVENTION

1. Field of the Invention

The present invention relates to a computer readable recording medium in which a data management program for managing data concerning a plurality of users is recorded, and a data management system.

2. Description of the Related Art

In general, for a computer system, a user inputs necessary data, and the system executes a predetermined processing based on the input data.

For example, in a computer system for performing an airplane seat reservation management, the user inputs data such as a reserver name, credit card number, reservation data, departure place, destination, and desired seat class, and the system executes a reservation processing. The reservation processing itself is a logic applicable to all users, and the processing is executed in accordance with the input data.

In conventional systems such as the aforementioned seat reservation system of an airline or a railroad, individual dedicated systems have been constructed/utilized. However, with spread of Internet, it has been possible for the user to directly utilize seat reservation or another service via a browser.

During transmission/reception of data such as personal data and business data in Internet, wiretapping, modification, and identification are prevented by an encryption technique to ensure security.

As described above, the security of the data transmitted/received via Internet is secured, for example, by the encryption technique, and the like.

For example, user's seat reservation data in a seat reservation server is stored in a database. A log-in name/password for reserving a seat is set in the database. When the user knows the log-in name/password for reserving the seat, the user can refer to or operate all user data in the database. In general, a member (person in charge) of a system operation division knows the log-in name/password for reserving the seat. Therefore, under existing circumstances, security of the data in the database is kept by ethics of a person who knows the log-in name/password for reserving the seat, and there is a demand for enhancement of the security concerning protection of the data in the server.

On the other hand, a number of companies increases in which one-to-one marketing is performed utilizing Internet technique in order to enhance user's sense of satisfaction.

Such company provides a service of displaying an introduction page of a commodity which might interest the user from a user's access log, or introducing a content in accordance with a user's utilization result. Thereby, a service suitable for user's circumstances at that time can be provided.

However, in the conventional one-to-one marketing in the Internet technique, a program needs to be changed/needs to cope with preliminarily in order to change a processing pattern or a display pattern for each user.

For example, there is a service of displaying a menu screen, and next displaying an item selected from the items of the menu screen. In the service a certain user has a high probability of selecting a predetermined item from the menu screen.

In this case, in order to first display the screen including the item having a high probability of selection by the user, and then display the menu screen, the program for the screen needs to be changed in such a manner that the screen changes in order from the screen of the item having the high probability of selection to the menu screen.

However, there is a problem that the changing of the program for each user requires troublesome and time and complicates operation.

### BRIEF SUMMARY OF THE INVENTION

An object of the present invention is to provide a computer readable recording medium in which a data management program for appropriately managing data concerning each user and fulfilling a service to be provided to the user is recorded, and a data management system.

According to a first aspect of the present invention, there is provided a computer readable recording medium for recording a data management program for causing a computer to perform:

an access control function of permitting an access only to data concerning a designated user, when an access to data stored for a plurality of users occurs; and

an executing function of designating the user having performed an operation with respect to the access control function, and using the access control function to access the data concerning the user, when the access to the stored data is necessary in a processing based on the user's operation.

According to a second aspect of the present invention, there is provided a data management system comprising: data storage means for storing data for a plurality of users; access control means for permitting an access only to the data concerning a designated user, when an access to the data storage means occurs; and executing means for executing a processing based on an operation of the user, designating the user having performed the operation with respect to the access control means, and accessing the data storage means via the access control means, when an access to the data storage means is necessary in the processing.

According to a third aspect of the present invention, there is provided a data managing method comprising the steps of:

permitting an access only to data concerning a designated user, when an access to the data stored for a plurality of users occurs; and

designating the user having performed an operation with respect to an access control function, and using the access control function to access the data concerning the user, when an access to the stored data is necessary in a processing based on the operation of the user.

According to a fourth aspect of the present invention, there is provided a computer readable recording medium for recording a data management program for causing a computer to perform:

an access control function of permitting an access only to data concerning a designated system, when an access to data stored for a plurality of systems occurs; and

an executing function of designating the system having performed an operation with respect to the access control function, and using the access control function to access the data concerning the system, when the access to the stored data is necessary in a processing based on the operation of the system.

According to a fifth aspect of the present invention, there is provided a data management system comprising:

data storage means for storing data for a plurality of systems;

access control means for permitting an access only to the data concerning a designated system, when an access to the data storage means occurs; and

executing means for executing a processing based on an operation of the system, designating the system having performed the operation with respect to the access control means, and accessing the data storage means via the access control means, when an access to the data storage means is necessary in the processing.

According to a sixth aspect of the present invention, there is provided a data managing method comprising the steps of:

permitting an access only to data concerning a designated system, when an access to the data stored for a plurality of systems occurs; and

designating the system having performed an operation with respect to an access control function, and using the access control function to access the data concerning the system, when an access to the stored data is necessary in a processing based on the operation of the system.

According to the present invention, since the access control function of limiting the access to the stored data only to the access to the data concerning the user is used, any other user or even a member of a system operation division cannot easily read others' data, and security of the system can be enhanced. For example, even when a log-in name/password used for developing or managing the executing function exists, only each user can access the data concerning the user.

Moreover, the designated processing to be performed for the corresponding user is stored, and the designated processing is executed by the executing function. Therefore, the processing appropriate for the user can be performed. Additionally, when a content of the stored data is changed, the processing to be performed for the corresponding user can easily be changed, and the service for the user can be fulfilled.

Furthermore, not only the data stored for each user but also the data stored for each processing system can be managed/executed.

Additionally, when the stored data content is changed, for example, an order of a display screen can easily be changed for each user, and the service for the user can be fulfilled.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing a data management system according to a first embodiment of the present invention.

FIG. 2 is a diagram showing a concrete example of a memory content of a database of the data management system shown in FIG. 1.

FIG. 3 is a flowchart showing an operation of an executing section in the data management system shown in FIG. 1.

FIG. 4 is a block diagram showing a constitution of the data management system according to a second embodiment of the present invention.

FIG. 5 is a diagram showing that a screen provided in the data management system shown in FIG. 4 differs with a user.

FIG. 6 is a block diagram showing the data management system according to a third embodiment of the present invention.

FIG. 7 is a diagram showing a concrete example of the memory content of the database of the data management system shown in FIG. 6.

FIG. 8 is a flowchart showing the operation of the executing section in the data management system shown in FIG. 6.

### DETAILED DESCRIPTION OF THE INVENTION

A preferred embodiment of the present invention will be described hereinafter with reference to the drawings.

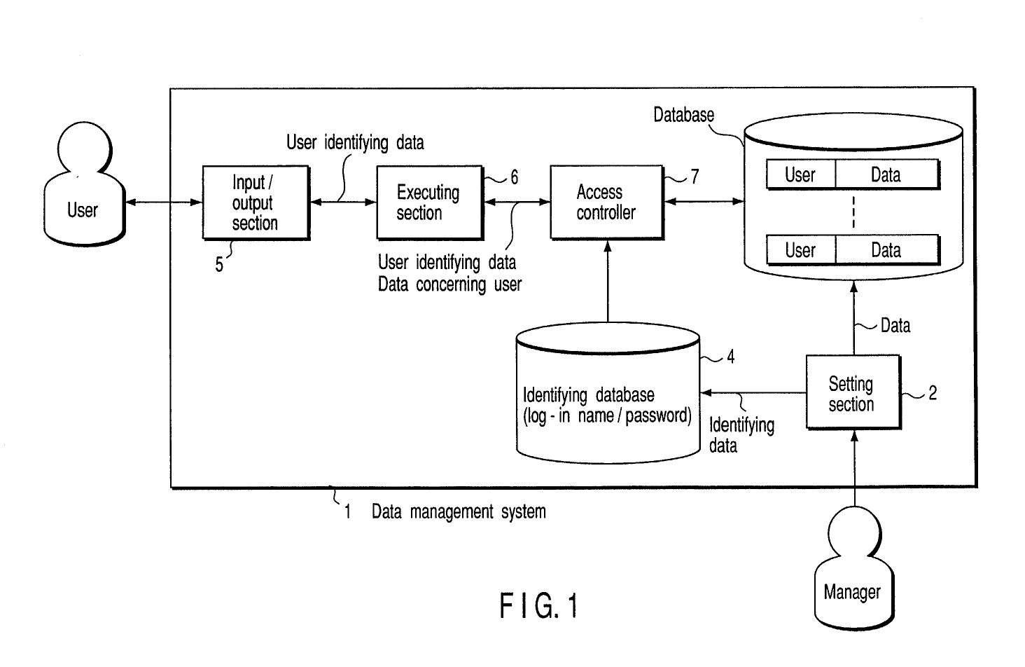

FIG. 1 is a block diagram showing a constitution of a data management system according to the present invention.

A data management system 1 is constituted of a setting section 2 associated mainly with an operation of a manager, a database 3, an identifying database 4, an input/output section 5 associated with an operation of a user, an executing section 6, and an access controller 7.

The setting section 2 relates data concerning users with the respective users based on a manager's setting and stores the data in the database 3. Moreover, the setting section 2 stores identifying data concerning each user in the identifying database 4 based on a manager's setting.

The database 3 stores the data concerning the user for each user. Examples of the database 3 include a database management system and relational database management system. Here, the database 3 is divided into respective user regions.

The identifying database 4 stores identifying data including a log-in name and password for identifying the user during access to the database 3.

The input/output section 5 inputs a user's operation content, outputs the content to the executing section 6, inputs a result via the executing section 6, and outputs the result to the user.

The executing section 6 executes a processing based on the user's operation content. Additionally, when the data concerning the user is required in the processing of the executing section 6, the executing section 6 outputs the user identifying data (including the log-in name/password of the section) designated beforehand by the user to the access controller 7. Moreover, the executing section accesses the database 3 via the access controller 7, and obtains the data concerning the user. Furthermore, the executing section 6 outputs a processing result to the input/output section 5.

During access to the database 3, the access controller 7 accesses the identifying database 4 based on the user identifying data inputted via the executing section 6. Moreover, when the user identifying data coincides with any identifying data set in the identifying database 4, the controller accesses only the data concerning the user in the database 3, and outputs the data to the executing section 6. Additionally, when the user identifying data does not coincide with any identifying data set in the identifying database 4, the controller outputs an error message to the executing section 6.

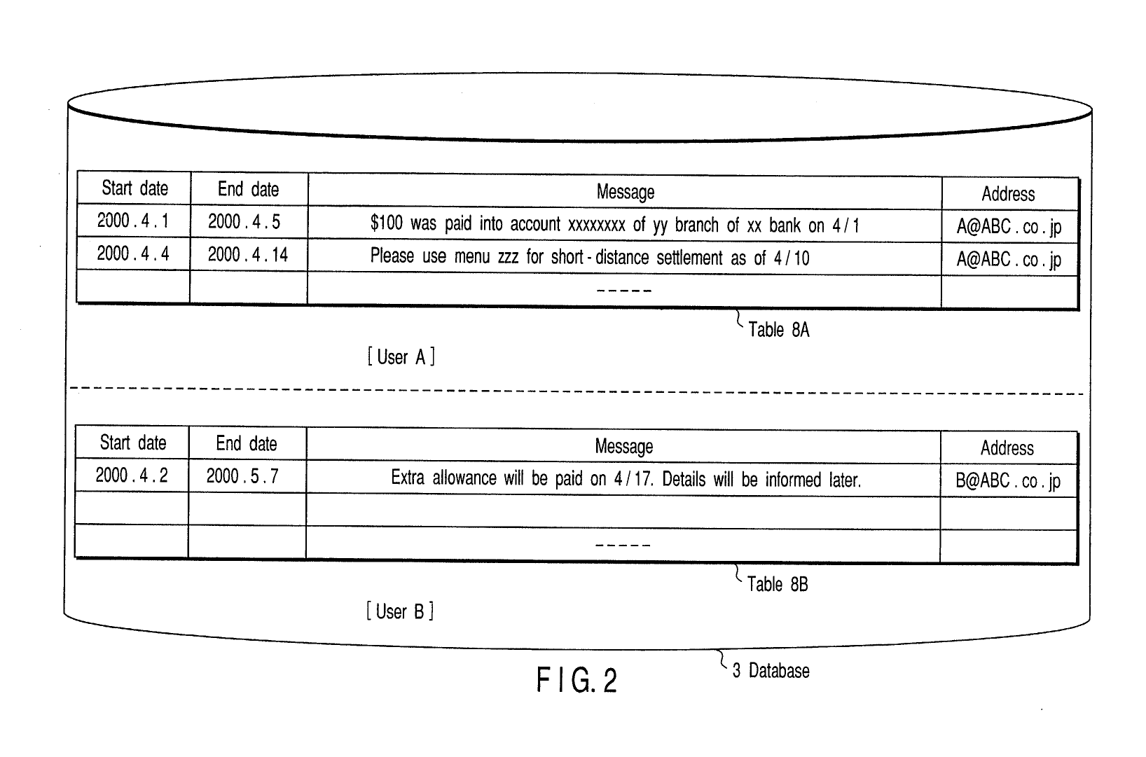

FIG. 2 shows a concrete example of a memory content of the database 3.

The users A, B are registered as log-in users in the database 3, and tables 8A, 8B for the respective users A, B are prepared in the respective user regions. The table 8A or 8B includes items “message”, “address”, and “valid period (valid period start date and end date).

For example, a message informing payment is stored in the table 8A for the user A, and a message informing that an extra allowance will be paid is stored in the table 8B for the user B.

An operation of the data management system 1 constituted as described above will be described hereinafter.

A manager of the data management system 1 presets the identifying data via the setting section 2, and stores the content in the identifying database 4. Moreover, the manager presets the data concerning each user via the setting section 2, and stores the content in the database 3.

Here, when a certain user inputs the user identifying data via the input/output section 5, the executing section 6 takes the user identifying data.

Subsequently, the executing section 6 outputs the user identifying data to the access controller 7.

The access controller 7 accesses the identifying database 4, collates the user identifying data inputted from the executing section 6 with the user identifying data registered in the identifying database 4, and checks whether or not these data coincide with each other. When the data coincide with each other, the access controller 7 reads the coincident data concerning the user from the database 3, and outputs the data to the executing section 6.

The executing section 6 uses the data concerning the user from the access controller 7 as a parameter to execute the processing, and outputs the processing result to the user via the input/output section 5.

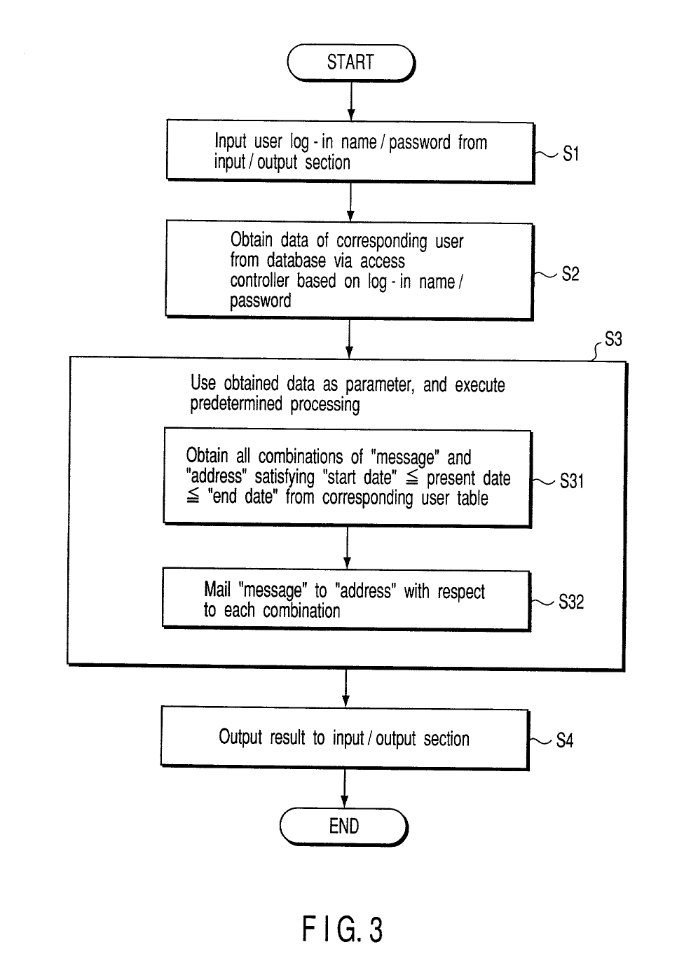

FIG. 3 is a flowchart showing an operation of the executing section 6 in the data management system 1.

First, the executing section 6 inputs the user identifying data including the log-in name/password from the input/output section 5 (S1), and reads the data concerning the corresponding user from the database 3 via the access controller 7 based on the log-in name/password (S2).

Subsequently, the executing section 6 uses the read data as the parameter to execute a predetermined processing (S3). For example, the executing section obtains all combinations of messages and addresses in which the present date is included between “start date” and “end date” from the table for the accessed user (S31), and mails/transmits the message concerning each combination to the address (S32).

Subsequently, the executing section 6 outputs the result to the input/output section 5 (S4). By this processing, the message for the user is read from the table, and mailed to the designated address. Each user can access the data management system 1 to obtain the message for the user, and a content of the mail is protected from the other users.

As described above, the data management system 1 includes the access controller 7 for limiting the access to the database 3 to the access to the data of the user. Therefore, even when the user sends a request for the processing, only the data of the user can be read. The other users and a member of a system operation division cannot access personal and business data of the user, and there can be provided a system having a high security.

Additionally, an example in which the data concerning the user is the message for the user has been described in the present embodiment, but various parameters of the processing executed by the executing section 6 as described above can be used as the data concerning the user.

Another embodiment will next be described. According to the first embodiment, when the data is accessed based on the user's operation, the access is limited only to the data of the user itself in the data management system as described above. On the other hand, in a second embodiment, when designated data of a display file is accessed based on the user's operation in the data management system, the access is limited only to the designated data of the user itself.

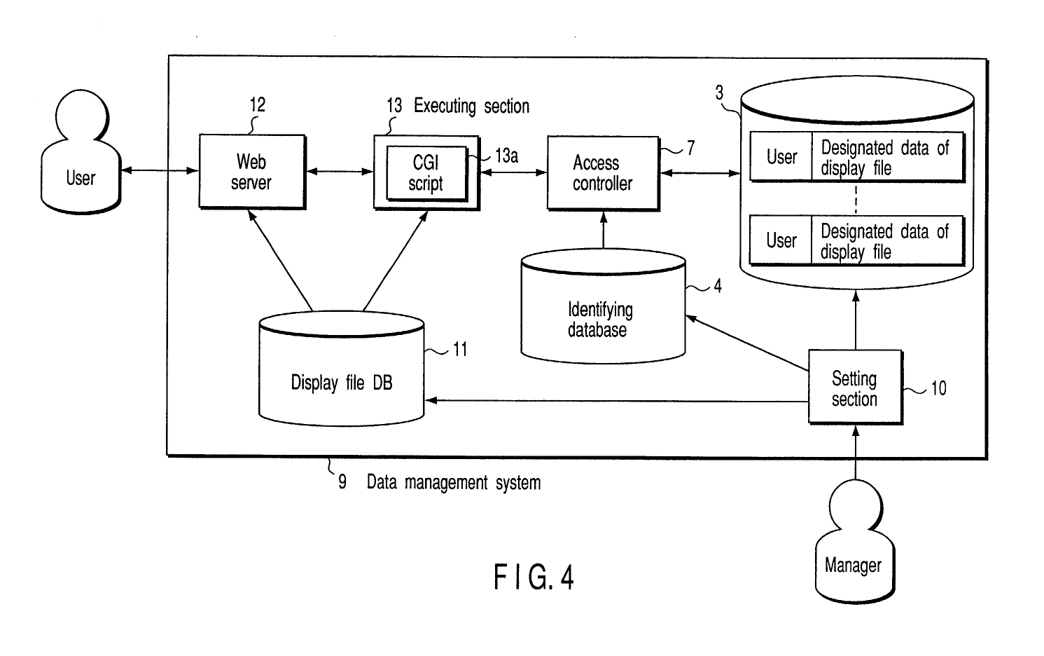

FIG. 4 is a block diagram showing a constitution of a data management system 9. Additionally, the same part as that of FIG. 1 is denoted with the same reference numerals, and the description thereof is omitted.

In the embodiment, the data management system 9 is a Web system as a display for the user.

A manager stores designated data of the display file to be displayed (display data) in the database 3 via a setting section 10 for each user, and stores the identifying data in the identifying database 4.

Moreover, the manager stores an actual display file beforehand in a display file database 11 via the setting section 10.

When the user accesses the data management system 9 via a Web server 12, a common gateway interface (CGI) script 13a of an executing section 13 is started.

The CGI script 13a inputs the user identifying data designated by the user via the Web server 12, and uses the user identifying data to access the database 3 via the access controller 7.

The CGI script 13a uses the designated data of the display file concerning the corresponding user obtained by the access to the database 3, reads the display file indicated by the designated data from the display file database 11, and returns the file to the Web server 12.

The display file to be displayed can be set for each user by the aforementioned operation of the data management system 9. That is, when the manager changes the memory content of the database 3, the display content for the user can be changed without changing the processing of the CGI script 13a.

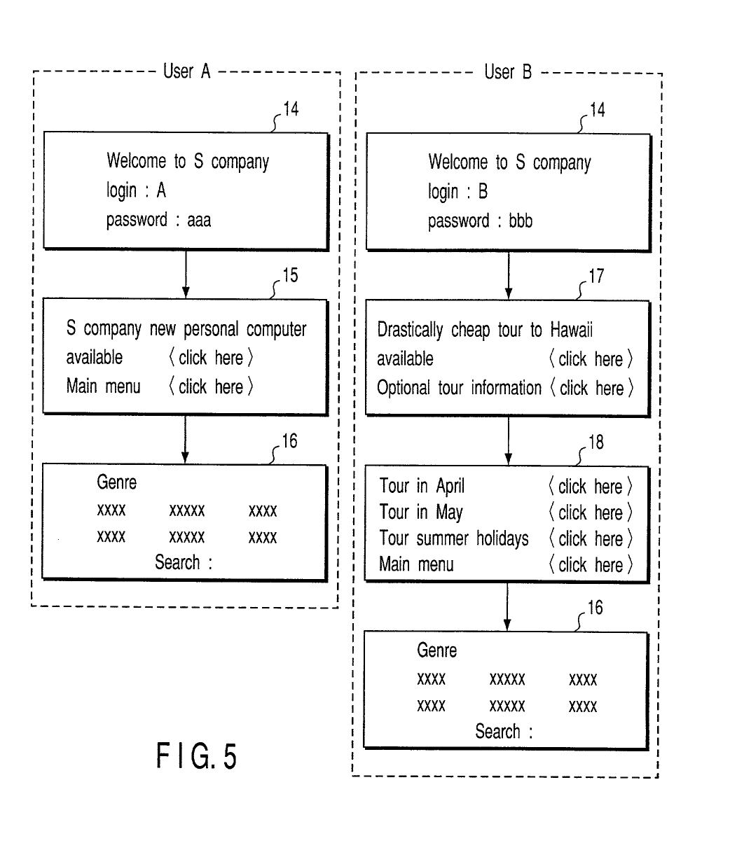

FIG. 5 is a diagram showing that a screen provided in the data management system 9 differs with the user.

An input screen 14 of the log-in name/password is first displayed for the user A. Upon inputting the screen 14 by the user A, the designated data of the display file for the user A is accessed, and the display file corresponding to the designated data is read from the display file 11 by the CGI script 13a based on the accessed designated data. As a result, for example, a selection screen 15 concerning “S company new personal computer available” and “main menu” is displayed.

Here, when the user A selects “main menu” from the selection screen 15, a main menu screen 16 is displayed.

On the other hand, the input screen 14 of the log-in name/password is first displayed for the user B. Upon inputting the screen 14 by the user B, the designated data of the display file for the user B is accessed, and a selection screen 17 concerning “drastically cheap tour to Hawaii available” and “optional tour information” is displayed based on the accessed designated data.

Here, when the user B selects “drastically cheap tour to Hawaii available” from the selection screen 17, a selection screen 18 concerning “tour in April”, “tour in May”, “tour in summer holidays”, “main menu” is displayed.

When the user B selects “main menu” from the selection screen 18, the main menu screen 16 is displayed.

The data management system 9 is effective, for example, when a display content and processing are changed in accordance with the user or circumstances in Internet mall.

As described above, in the data management system 9 of the second embodiment, the manager can change the processing for each user only by setting the memory content of the database 3 without changing the CGI script 13a or another program. Therefore, the service for the user can be enhanced, and a manager's management burden can be reduced.

Additionally, for the data management systems 1, 9 of the first and second embodiments, if the similar action/function can be realized, arrangement of respective constituting elements may be changed, or the respective constituting elements may freely be combined.

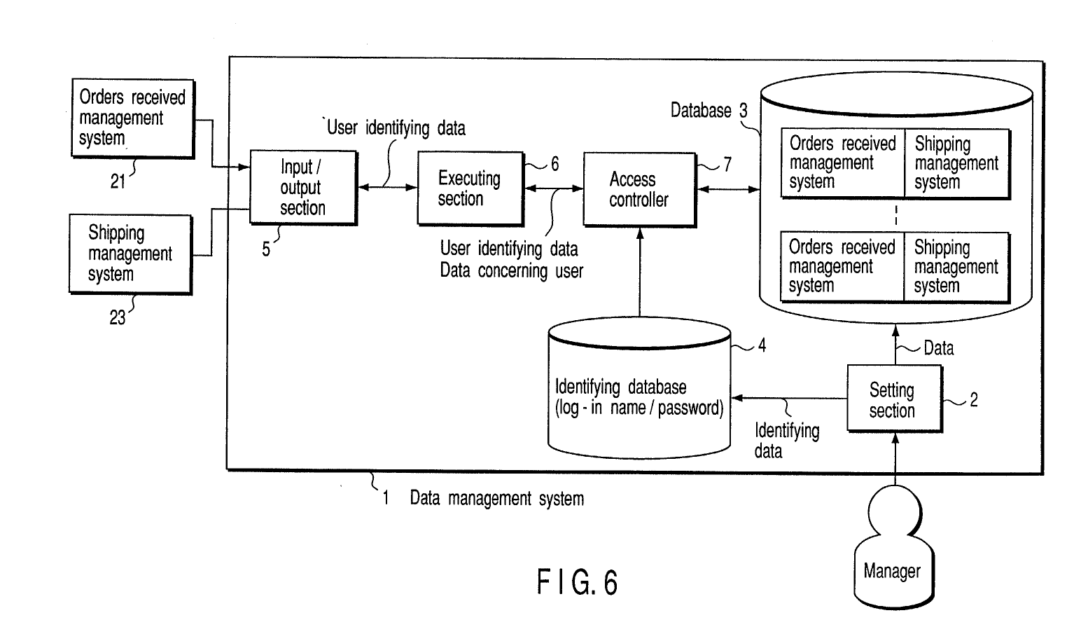

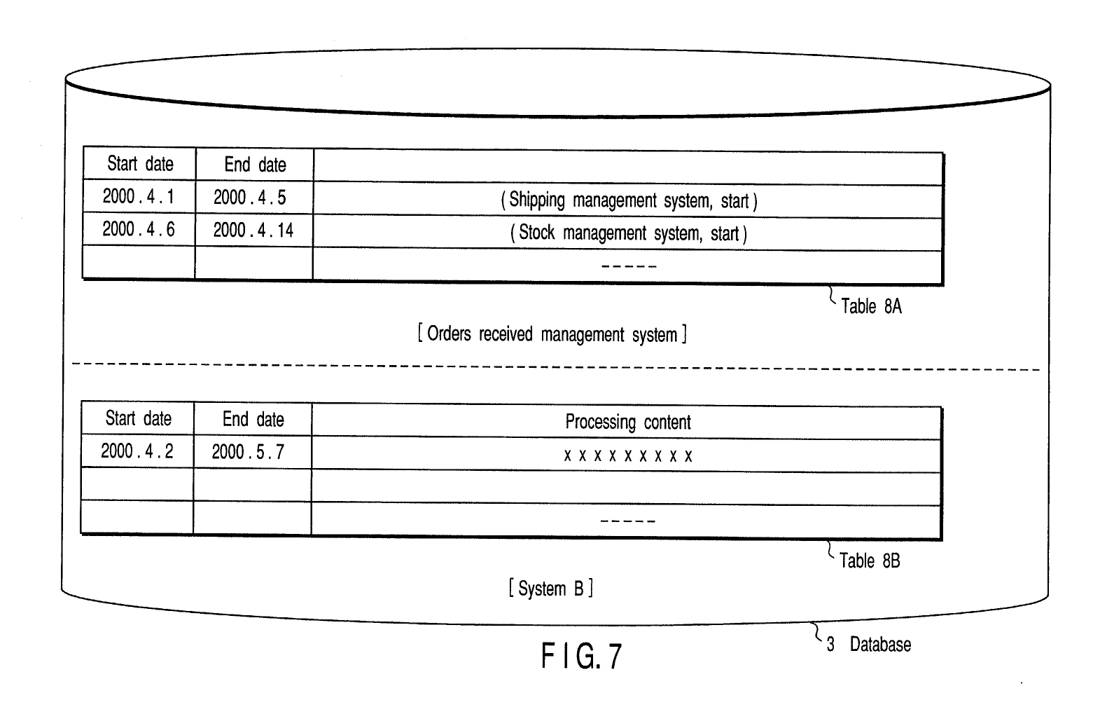

In the aforementioned embodiments, the management/execution of the data stored for each user has been described. However, the present invention is not limited to the embodiments. For example, the present invention can also be applied to the management/execution of the data stored not only for each user but also for each processing system. For example, as shown in FIG. 6, the log-in name/password for an orders received management system 21 is inputted to the input/output section 5 from the orders received management system 21. Then, in order to access the database 3 shown in FIG. 7, the access controller 7 judges accessibility based on the input log-in name/password for the orders received management system 21, and the data of the identifying database 4. When the database 3 can be accessed, and the identifying data for the orders received management system coincides with any data of the identifying database 4, only the data concerning the system is accessed and output to the executing section 6. In FIG. 7, for the data concerning the orders received management system, it is assumed that a shipping management system started between Apr. 1 and Apr. 5, 2000, and a stock management system started between Apr. 6 and Apr. 14, 2000. This data is used as the parameter and output to the executing section 6.

Moreover, for example, when the present date is Apr. 4, 2000, the executing section 6 executes a processing (stock management system, start). Therefore, processing content (stock management system, start) is obtained. Subsequently, a processing name to be started next “shipping management system” is obtained. Then, the input/output section 5 starts a shipping management system 23.

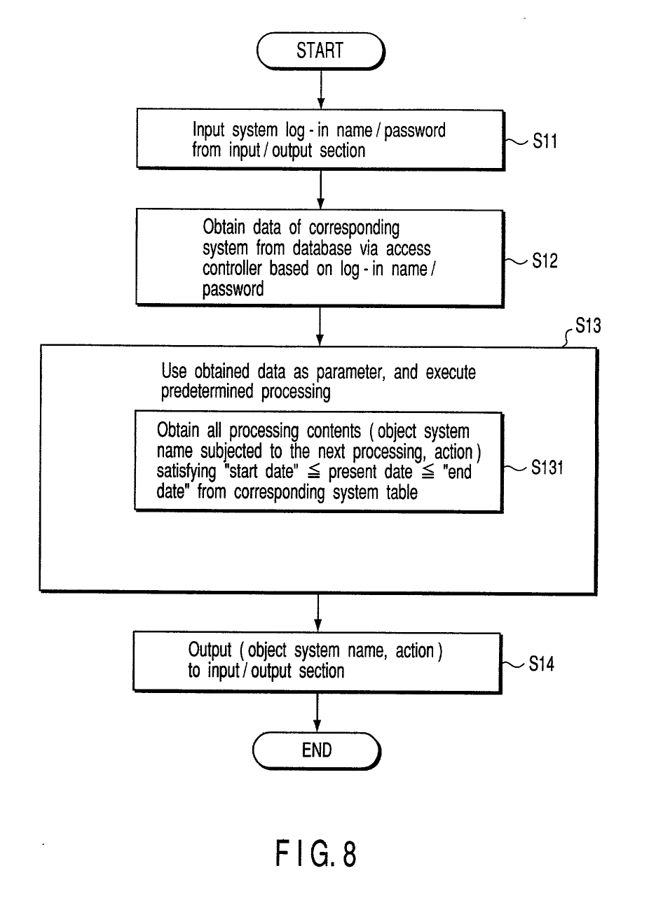

FIG. 8 is a flowchart showing the processing for managing/executing the data stored for each processing system. In step S11, the system log-in name/password is input from the input/output section 5. Subsequently, in step S12, the data of the corresponding system is obtained from the database 3 via the access controller 7 based on the log-in name/password. That is, (shipping management system, start) and (stock management system, start) are obtained. Subsequently, in step S13, the obtained data is used as the parameter to execute the predetermined processing. That is, in step S131, all processing contents (object system name subjected to the next processing, action) satisfying “start date”≦present date≦“end date” are obtained from the corresponding system table. For example, when the present date is Apr. 4, 2000, the processing to be executed by the executing section 6 is (shipping management system, start), and therefore the processing content (shipping management system, start) is obtained. Subsequently, in step S14, (object system name, action) is output to the input/output section 5. That is, for example, (shipping management system, start) is output to the input/output section 5.

Moreover, the respective functions and elements of the data management systems 1, 9 can be written as programs executable by a computer into recording mediums such as a magnetic disk (floppy disk, hard disk, and the like), optical disk (CD-ROM, DVD, and the like), and semiconductor memory and applied. It is also possible to transmit the program via a communication medium and apply the program to a computer, or a computer system.

The computer for realizing the aforementioned respective functions reads the program recorded in the recording medium, and executes the aforementioned processing, while the operation of the computer is controlled by the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer readable recording medium for recording a data management program for causing a computer to perform:
an access control function of permitting an access only to data concerning a designated user, when an access to data stored for a plurality of users occurs; and
an executing function of designating the user having performed an operation with respect to said access control function, and using said access control function to access the data concerning said user, when the access to said stored data is necessary in a processing based on the operation of the user.

2. The recording medium according to claim 1, wherein the data concerning said user is designation of the processing to be executed, and
said executing function executes the processing designated by the data read using said access control function.

3. The recording medium according to claim 1, wherein the data concerning said user is designation of display data to be provided, and
said executing function provides the display data designated by the data read using said access control function.

4. A data management system comprising:
data storage means for storing data for a plurality of users;
access control means for permitting an access only to the data concerning a designated user, when an access to said data storage means occurs; and
executing means for executing a processing based on an operation of the user, designating the user having performed said operation with respect to said access control means, and accessing said data storage means via said access control means, when an access to said data storage means is necessary in the processing.

5. The system according to claim 4, wherein the data stored in said data storage means is designation of the processing to be executed for each user, and
said executing means executes the processing designated by the data read via said access control means among a plurality of processings with respect to the user having performed said operation.

6. The system according to claim 4, wherein the data stored in said data storage means is designation of display data to be provided for each user, and
said executing means provides the display data designated by the data read via said access control means among a plurality of pieces of display data for the user having performed said operation.

7. The system according to claim 4, wherein said executing means is a CGI script.

8. A data managing method comprising the steps of:
permitting an access only to data concerning a designated user, when an access to the data stored for a plurality of users occurs; and
designating the user having performed an operation with respect to an access control function, and using said access control function to access the data concerning said user, when an access to said stored data is necessary in a processing based on the operation of the user.

9. The method according to claim 8, wherein the data concerning said user is designation of the processing to be executed, and
an executing step executes the processing designated by the data read using said control function.

10. The method according to claim 8, wherein the data concerning said user is designation of display data to be provided, and
an executing step provides the display data designated by the data read using said access control function.

11. A computer readable recording medium for recording a data management program for causing a computer to perform:
an access control function of permitting an access only to data concerning a designated system, when an access to data stored for a plurality of systems occurs; and
an executing function of designating the system having performed an operation with respect to said access control function, and using said access control function to access the data concerning said system, when the access to said stored data is necessary in a processing based on the operation of the system.

12. The computer readable recording medium for recording the data management program according to claim 11, wherein the data concerning said system is designation of the processing to be executed, and said executing function executes the processing designated by the data read using said access control function.

13. A data management system comprising:
data storage means for storing data for a plurality of systems;
access control means for permitting an access only to the data concerning a designated system, when an access to said data storage means occurs; and
executing means for executing a processing based on an operation of the system, designating the system having performed said operation with respect to said access control means, and accessing said data storage means via said access control means, when an access to said data storage means is necessary in the processing.

14. The system according to claim 13, wherein the data stored in said data storage means is designation of the processing to be executed with respect to the system, and
said executing means executes the processing designated by the data read via said access control means among a plurality of processings with respect to the system having performed said operation.

15. The system according to claim 13, wherein said executing means is a CGI script.

16. A data managing method comprising the steps of:
permitting an access only to data concerning a designated system, when an access to the data stored for a plurality of systems occurs; and
designating the system having performed an operation with respect to an access control function, and using said access control function to access the data concerning said system, when an access to said stored data is necessary in a processing based on the operation of the system.

17. The method according to claim 16, wherein the data concerning said system is designation of the processing to be executed, and an executing step executes the processing designated read using said access control function.
